(19) United States
(12) Patent Application Publication
(10) Pub. No.: US 2012/0079547 A1
(43) Pub. Date: Mar. 29, 2012

(54) Multimedia Network Interface Device with Table-Based Connection Management

(76) Inventors: Seong-Hwan Kim, Allentown, PA (US); Sundar Vedantham, Allentown, PA (US)

(21) Appl. No.: 12/889,627

(22) Filed: Sep. 24, 2010

(51) Int. Cl. H04N 7/173

(52) U.S. Cl. 725/111; 725/131; 725/118

(57) ABSTRACT

A set-top box or other network interface device incorporates functionality for distributing multimedia signals to multiple televisions or other terminal devices within a residence or other facility. In one aspect, the network interface device comprises a processor, a memory coupled to the processor, first network interface circuitry for receiving multimedia signals from an access network, and second network interface circuitry for communicating over a local network with a plurality of terminal devices. The network interface device is operative under control of the processor to deliver selected ones of the multimedia signals to the terminal devices responsive to control commands received from the terminal devices. The memory of the network interface device stores a connection management table indicating for each of the terminal devices at least a selected one of the multimedia signals and status information for that terminal device.

### FIELD OF THE INVENTION

The present invention relates generally to communication systems, and more particularly to techniques for distributing multimedia signals from a set-top box or other network interface device to multiple terminal devices.

### BACKGROUND OF THE INVENTION

In a typical residential implementation of a subscription multimedia service, a separate set-top box (STB) is generally associated with each television or other terminal device in the various rooms of a residence. The multimedia signals of the service are delivered to the residence via a cable system, a digital subscriber line (DSL) system, a satellite television system, an Internet Protocol (IP) television system, or another type of multimedia signal delivery system. In such systems, the corresponding service provider often owns the STBs and may charge the residential user on a monthly basis for each installed STB. As many residences today have a large number of televisions, the requirement of a separate STB for each television unduly increases the costs associated with obtaining the multimedia service.

A number of techniques have been developed that utilize a single STB to support multiple televisions within a given residence. See, for example, U.S. Patent Application Publication No. 2007/0107019, entitled “Methods and Apparatus for an Integrated Media Device,” U.S. Patent Application Publication No. 2009/0044226, entitled “Interactive Television Program Guide System Having Multiple Devices within a Household,” and U.S. Patent Application Publication No. 2003/0192061, entitled “Set-Top Box System and Method for Viewing Digital Broadcast.” However, these and other conventional techniques are generally not efficient or cost-effective. For example, certain techniques can have difficulty providing substantially uninterrupted service as users move from room to room within a residence or other facility, while others are limited in terms of the number of televisions or other terminal devices that can be supported. Also, one or more of these techniques can require significant changes to network infrastructure from multiple vendors, and are therefore expensive and difficult to implement.

Accordingly, a need exists for an improved approach to configuring an STB or other network interface device to support delivery of multimedia signals to multiple televisions or other terminal devices.

### SUMMARY OF THE INVENTION

Illustrative embodiments of the present invention overcome the above-noted drawbacks of conventional practice by providing an STB or other network interface device which incorporates a connection management table and associated control logic implemented primarily in software for efficient and cost-effective control of multimedia signal distribution to multiple televisions or other terminal devices within a given residence or other facility.

In accordance with one aspect, a network interface device comprises a processor, a memory coupled to the processor, first network interface circuitry for receiving multimedia signals from an access network, and second network interface circuitry for communicating over a local network with a plurality of terminal devices. The network interface device is operative under control of the processor to deliver selected ones of the multimedia signals to the terminal devices responsive to control commands received from the terminal devices. The memory of the network interface device stores a connection management table indicating for each of the terminal devices at least a selected one of the multimedia signals and status information for that terminal device.

The connection management table in one of the illustrative embodiments comprises an active list and a pause list, with each of at least a subset of the terminal devices being on one of the active list and the pause list. A given entry in one of the active list and the pause list may identify a particular one of the terminal devices and a particular one of the multimedia signals currently selected by that terminal device. In maintaining the connection management table, the network interface device may detect that a given one of the terminal devices has transitioned from an on state to an off state, and responsive to that transition, remove the given terminal device from the active list and add that terminal device to the pause list. The network interface device then displays the pause list on at least one of the terminal devices other than the given terminal device in conjunction with the other terminal device transitioning from an off state to an on state. When the network interface device detects selection by the other terminal device of a particular one of the multimedia signals from the displayed pause list, it sends the selected multimedia signal to that other terminal device. The network interface device then removes the other terminal device from the pause list and adds that terminal device to the active list.

The illustrative embodiments of the invention provide a number of significant advantages over the conventional techniques previously described. For example, the connection management table and its associated control logic can be implemented primarily in software which can be readily stored in an internal memory of an otherwise conventional STB. This arrangement facilitates the provision of substantially uninterrupted service as users move from room to room within a residence or other facility. Also, the illustrative embodiments are easily scalable to allow a single STB to support any desired number of televisions or other terminal devices within a residence or other facility, subject to bandwidth constraints of an associated local network over which the STB communicates with the terminal devices.

### BRIEF DESCRIPTION OF THE DRAWINGS

FIG. 1 is a block diagram of a communication system in an illustrative embodiment.

FIG. 2 is a more detailed view of a set-top box of the FIG. 1 system.

FIG. 3 is a flow diagram illustrating the operation of the set-top box of FIG. 2.

FIG. 4 shows an example of a connection management table maintained by the set-top box for controlling distribution of multimedia signals to multiple televisions in different rooms of a residence.

### DETAILED DESCRIPTION OF THE INVENTION

The invention will be illustrated herein in conjunction with an exemplary communication system which includes one or more set-top boxes each having multimedia signal distribution functionality configured in a particular manner. More specifically, the invention will be illustrated in conjunction with a DSL system. It should be understood, however, that the invention is applicable to other types of communication systems and more generally to any multimedia signal distribution application in which signals are to be distributed from a network interface device to multiple display terminals within a residence or other facility. For example, other embodiments can be implemented in a satellite television system, an IP television system, or another type of multimedia signal delivery system.

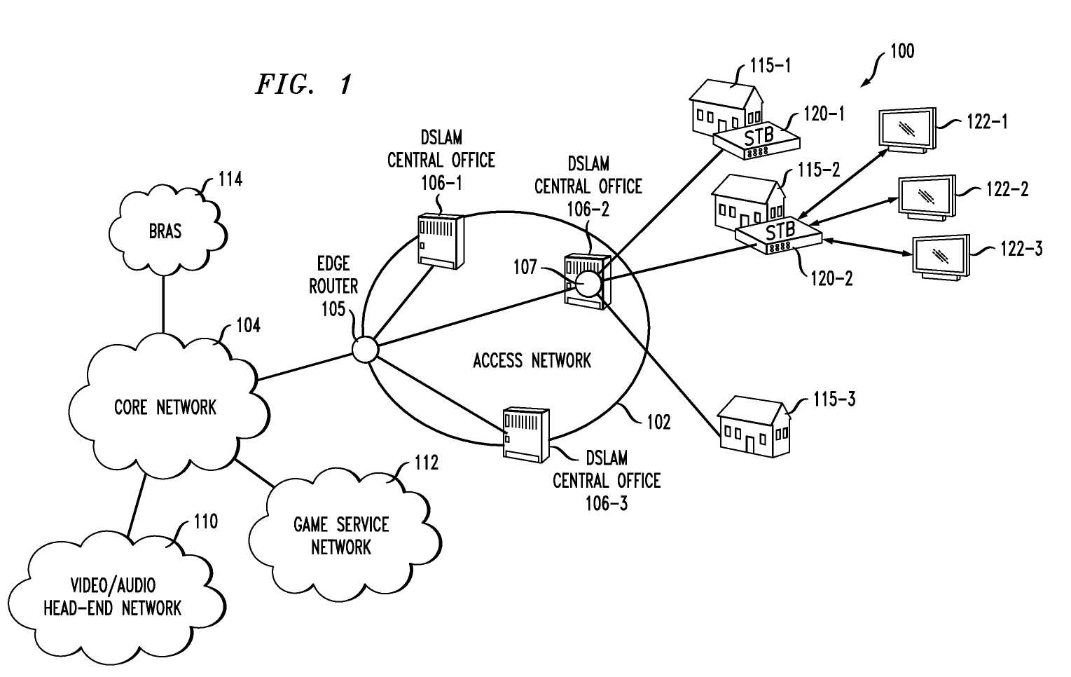

FIG. 1 shows a network-based communication system 100 in an illustrative embodiment of the invention. The communication system 100 includes an access network 102 coupled to a core network 104 via an edge router 105. The access network 102 includes central offices 106-1, 106-2 and 106-3, each of which is assumed to incorporate a DSL access multiplexer (DSLAM). A given central office 106 in the system 100 typically will not include a router, although in alternative embodiments utilizing next generation central offices such a central office may have an associated router, illustratively shown in the figure as router 107. Also coupled to the core network 104 are a video/audio head-end network 110, a game service network 112, and a broadband remote access server (BRAS) 114. The DSLAMs are not required, and other types of arrangements, such as service ports, may be used within the access network 102.

In the system 100, multimedia signals from the head-end network 110, game service network 112 and BRAS 114 are delivered via core network 104 and access network 102 to residences 115-1, 115-2 and 115-3. Each of the residences 115 is assumed to have a single STB 120 associated therewith, although only STBs 120-1 and 120-2 associated with respective residences 115-1 and 115-2 are explicitly shown. Each of the STBs 120 receives multimedia signals from access network 102, and delivers selected ones of the multimedia signals to associated terminal devices responsive to control commands received from the terminal devices. For example, as shown in the figure, STB 120-2 located at residence 115-2 delivers multimedia signals to terminal devices 122-1, 122-2 and 122-3, which comprise respective televisions. Although not shown in the figure, other sets of terminal devices may be associated with each of the other STBs 120. Thus, in the present embodiment, each of the STBs 120 is configured to support multiple televisions 122 or other terminal devices such as computers, mobile telephones, wireless email devices, gaming systems, music systems, etc. The STBs are examples of what are more generally referred to herein as “network interface devices.”

The STBs 120 support streaming of a wide variety of different types of multimedia signals to these and other terminal devices, including, for example, video, music, gaming content, Internet pages and other multimedia content. The term “multimedia signal” as used herein is intended to be broadly construed so as to encompass any such signals. As will be described in greater detail below, each of the STBs 120 maintains a software-based connection management table indicating for each of its associated televisions or other terminal devices at least a selected one of the multimedia signals and status information for that terminal device. Thus, in the context of the FIG. 1 embodiment, the connection management table maintained on a given STB 120 is used to keep track of what media content is being viewed on which television 122 in order to provide a continuous video streaming experience, thereby allowing the desired content to follow the users from television to television within the residence 115.

In one possible scenario, the tracked multimedia content may include video-on-demand (VoD) movies currently being watched on respective televisions 122 in the corresponding residence 115. When one of the televisions is turned off by a system user, the movie that was playing on that television is added to a pause list which is part of the above-noted connection management table. Assume the user then walks into another room in the residence and turns on the television set in that room. The user can continue watching the movie on the new television from the point where it was turned off on the other television, by selecting it from the pause list as displayed on the new television.

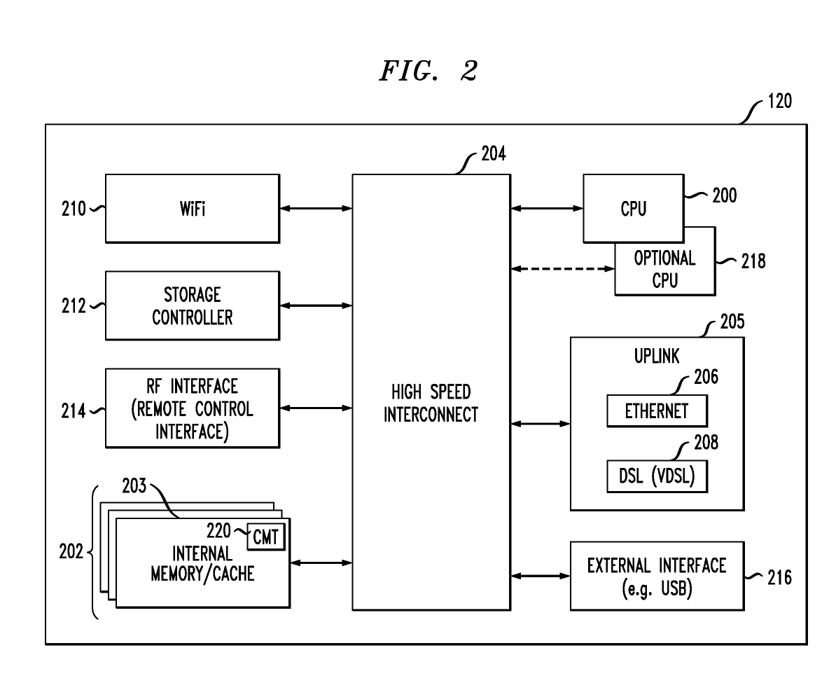

FIG. 2 shows a more detailed view of a given one of the STBs 120 of communication system 100. In this embodiment, the STB comprises a processor 200 and a memory 202. The processor 200 is illustratively implemented as a central processing unit (CPU). The memory 202 comprises multiple instances of an internal memory/cache 203 of the STB 120. The processor 200 and memory 202 communicate via a high speed interconnect 204, which may comprise a bus. Also coupled to the interconnect 204 is access network interface circuitry 205, illustratively comprising Ethernet interface 206 and DSL interface 208 for supporting communications between the STB 120 and respective DSLAMs or service ports of the access network 102. In other embodiments, other types of interface circuitry may be used to support communications between the STB 120 and the access network 102, such as cable modem circuitry, satellite transceiver circuitry, etc. The STB 120 further includes a WiFi module 210, a storage controller 212, an RF interface 214, an external interface 216 (e.g., a USB port), and an optional additional CPU 218, all of which are also coupled to the interconnect 204. A connection management table 220 is stored in internal memory/cache 203 of memory 202.

At least a subset of the components of the STB 120 may be implemented in the form of one or more integrated circuits, such as a microprocessor, digital signal processor (DSP), application-specific integrated circuit (ASIC), field-programmable gate array (FPGA), or other type of data processing device, as well as portions or combinations of these and other devices. For example, one or more of the elements 200, 202, 204, 205, 210, 212, 214, 216 and 218 may each be implemented as a separate integrated circuit or alternatively multiple such elements may be combined into a single integrated circuit.

The memory 202 may be used to store, in addition to connection management table 220, computer program code of one or more software programs. Such program code can be retrieved from the memory via storage controller 212 and executed in the CPU 200. The memory 202 may be viewed as an example of what is more generally referred to herein as a “computer program product” having executable computer program code embodied therein. The computer program code may be used to provide control logic associated with the connection management table 220, and when executed in CPU 200 causes the STB 120 to perform operations associated with distributing multimedia signals to a set of terminal devices and maintaining the connection management table 220. Other examples of computer program products embodying aspects of the invention may include, for example, optical or magnetic disks.

It will be assumed for purposes of further describing the operation of STB 120 of FIG. 2 that the STB supports multiple terminal devices in the form of a plurality of televisions 122, in the manner illustrated for STB 120-2 associated with residence 115-2 in system 100. The STB communicates with these televisions via a local network, which in this embodiment comprises a wireless local area network (WLAN) implemented using WiFi interface 210, configured in accordance with well-known standards such as IEEE 802.11n or 802.11b/g. Thus, all multimedia signal communications between the STB 120 and the televisions 122 in this embodiment is via WiFi, although other types of local networks could be used in other embodiments. The use of a high bandwidth WiFi standard interface in STB 120 provides sufficient bandwidth for high definition video and facilitates communication between the STB and a large number of televisions or other terminal devices distributed throughout a residence.

Associated with each of the televisions 122 is a remote control device that communicates control commands to the STB 120 via RF interface 214. In other embodiments, control commands can be exchanged between the televisions 122 and the STB 120 via the same WiFi interface 210 used to distribute the multimedia signals. Other types of arrangements can be used to support communications between the remote control device and the STB 120, such as AM, FM or otherwise unused radio frequencies. Also, the same remote control device is generally used to control the corresponding television, although such direct line-of-site control of the television could be implemented using conventional techniques such as infrared (IR).

The STB 120 can be located in one of the rooms of the residence 115 or in a closet or utility area, and as indicated above it delivers multimedia signals to each of the televisions 122 via the WiFi interface 210. The previously-mentioned television remote control device is used to perform local operations on the corresponding television, such as power on/off and volume control. For functions such as channel change, program guide, pause, play, rewind and fast forward, the associated control commands are communicated directly to the STB via the RF interface 214 or via WiFi interface 210 as previously noted. In other embodiments, the remote control device can communicate all commands to the television, with the television supplying the commands to the STB.

Thus, when a given one of the televisions 122 in residence 115 is turned on, that event is communicated to the STB 120. Control commands such as channel change commands, VoD selections, etc. are communicated to the STB 120 via the remote control device and RF interface 214 or via the television and WiFi interface 210. The STB then streams the required multimedia signal to the television via WiFi interface 210, and updates the connection management table 220 accordingly.

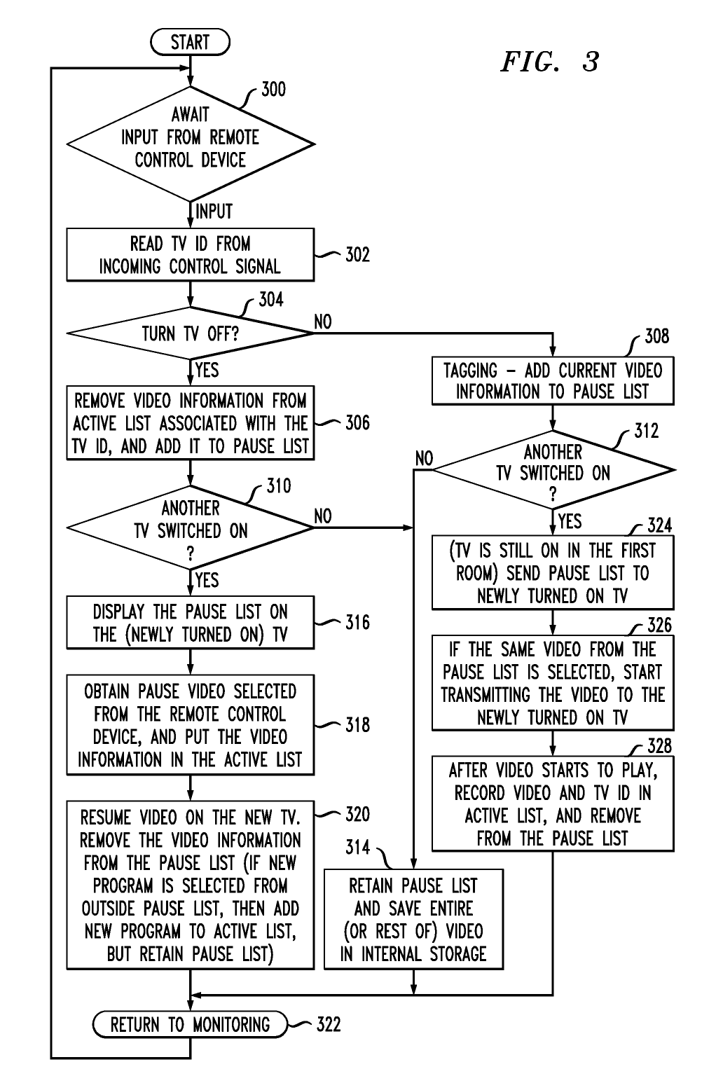

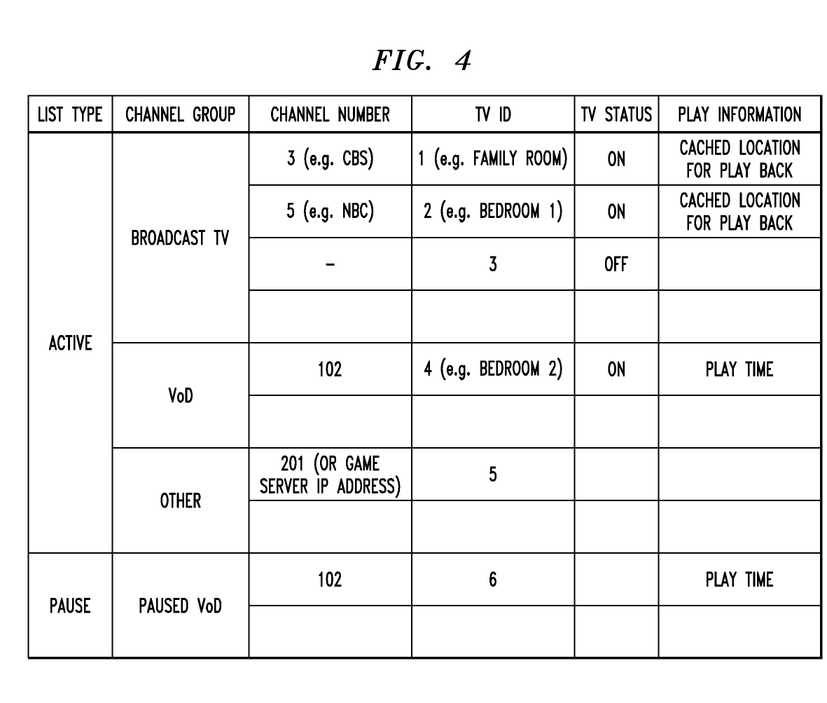

The manner in which the connection management table 220 is updated and otherwise maintained by the STB 120 will now be described in greater detail with reference to FIG. 3. This figure shows an exemplary connection management process performed by STB 120 in an illustrative embodiment of the invention. The process includes steps 300 through 328. The connection management table in this example is assumed to be of the form shown in FIG. 4. In this table, the channels selected at respective televisions are identified by corresponding channel numbers. The channels are separated in the table into channel groups, including broadcast TV, VoD and other, with each such group identifying a set of one or more channels by their respective channel numbers. The “other” group may comprise, for example, game channels, web surfing channels, a home hard drive channel, etc. These other channels may be identified by a channel number or alternatively an IP address of an associated server, e.g., a game server or home hard drive.

The connection management table of FIG. 4 more specifically includes columns for list type, channel group, channel number, TV identifier (ID), TV status and play information. The list type in this example table is either “active” or “pause.” The active or pause lists include entries with each such entry identifying a particular one of the televisions and a particular one of the multimedia signals currently selected by that television. Thus, for example, the television located in the family room of residence 115 has TV ID 1 and its currently selected channel number is Channel 3, which is a broadcast channel, such as CBS. Similarly, the television located in a first bedroom of residence 115 has TV ID 2 and its currently selected channel number is Channel 5, which is also a broadcast channel, such as NBC. Other televisions may currently have selected VoD channels, such as the television in a second bedroom of residence 115, which has TV ID 4, and has as its selected channel a VoD channel identified by channel number 102. The TV IDs can be programmed into the STB by the user, or automatically captured by the STB. Service providers can provide the needed information on available channel numbers.

The corresponding TV status information indicated in the connection management table 220 for a given one of the televisions 122 comprises an indicator as to whether the television is in an on state or an off state. It is to be appreciated, however, that the terms “on state” and “off state” are intended to be broadly construed, so as to encompass states in which, for example, a television or other terminal device is not fully turned on or fully turned off but is otherwise enabled or disabled from displaying multimedia signals. The play information may indicate, for example, a cached location in memory 202 for the corresponding multimedia signal, or a designated play time in the case of a VoD channel. The TV status and play information in the FIG. 4 connection management table are examples of what is more generally referred to herein as “status information.” It is to be appreciated that the particular table format shown in FIG. 4 is provided by way of illustrative example only, and numerous alternative table formats may be used in other embodiments of the present invention.

Referring now to the particular steps of FIG. 3, the STB 120 in step 302 awaits input from the remote control device of a given television. When this input is received in step 302, the STB reads the TV ID from the incoming control signal. If the input indicates that the user has entered a command to turn off the television, as determined in step 304, the video information associated with that television is removed from the active list and added to the pause list as indicated in step 306. Otherwise, a tagging operation is initiated in step 308 in which the current video information for that television is added to the pause list. The tagging operation is used in a situation in which a user moves to another room without turning off the television in the previous room, and is intended to inform the STB that the user is moving. It can be initiated by the user entering a corresponding tag command via the remote control device of the television in the previous room. The STB responds to the tag command by adding the current video information to the pause list while still playing that video on the television in the previous room.

Steps 310 and 312 determine if another television has been switched on in another room. If no other television has been switched on, the entire pause list is retained and the corresponding video signals or at least remaining portions thereof are stored in internal storage of memory 202 in STB 120, as indicated in step 314. The process in step 322 then returns to monitoring for additional control input from remote control devices.

However, if the determination in step 310 indicates that another television has been switched on, the pause list is displayed on that newly turned on television in step 316. The user can then select a channel for viewing from the displayed pause list, and the corresponding video information is added to the active list as indicated in step 318. The video is then resumed on the new television, and the video information is removed from the pause list, as shown in step 320. If the new program was selected from outside the pause list, it is added to the active list and the pause list is retained without modification. The process in step 322 then returns to monitoring for additional control input from remote control devices.

Also, if the determination in step 312 indicates that another television has been switched on, the pause list is sent to the newly turned on television and displayed there in step 316. The user can then select a channel for viewing from the displayed pause list. If the same video from the pause list is selected, the STB starts transmitting the video to the newly turned on television in step 326. After the video starts to play on that television, the video information including the channel number and TV ID is recorded in the active list and removed from the pause list, as indicated in step 328. The process in step 322 then returns to monitoring for additional control input from remote control devices.

It should be noted that the pause list need not be immediately displayed as soon as a television is turned on. For example, in other embodiments the television pause list may be displayed only when the user presses a particular button on the remote control. In such an embodiment, the television when turned on can simply display a designated channel, such as the most-recently displayed channel. The term “display” as used herein in association with the pause list should be understood to include these and other arrangements in which the pause list is displayed responsive to a remote control command or is otherwise not immediately displayed upon turn on of a television.

In the FIG. 3 process, when a given video program is in progress, the user may decide to move to a different room and continue watching the program there. Assume by way of example that the user is moving from the family room to the master bedroom. At this point, the user may turn the family room television off or leave it on while the user moves to the master bedroom to continue watching the program in progress. If the family room television is turned off, the STB places this program on the pause list as per step 306. The STB will continue downloading the stream and save it in memory 202. When the user turns on the television in the master bedroom, an initial screen displays the list of programs on the pause list as indicated in step 316. The user can then choose the program he or she wants to continue watching and the STB will then stream the program to the master bedroom television from the point where it was paused by entry of the video information onto the pause list when the family room television was turned off.

However, if the user intends to leave the television on in the family room, the user tags the current program by pressing a tag button on the remote control device in the family room, in accordance with step 308. As noted previously, this informs the STB that the user is moving to another room and wants to be able to access the current program in that room. When a tag input comes into the STB, the STB adds the program to the pause list, but it will keep playing video for the family room television. This arrangement advantageously allows one viewer to move to a different room of the residence while the rest of the family members can continue watching the same program in the family room.

As indicated previously, the content management table 220 is stored in internal memory of the STB 120. It may also or alternatively be stored in flash memory or other non-volatile memory of the STB between reboots.

It is to be appreciated that the particular process shown in FIG. 3 is presented by way of illustrative example only, and that alternative embodiments may use other types, orderings and arrangements of process steps.

An advantage of the illustrative arrangements described above is that the connection management table 220 and its associated control logic can be implemented primarily in the form of software stored in memory 202 of the STB 120. The connection management table stores terminal device identifiers, selected channels and associated status information for all of the terminal devices in the residence. Any number of televisions or other terminal devices within a given residence can be supported by a single STB in an efficient and cost-effective manner, subject to the bandwidth constraints of the WiFi network or other local network over which the STB communicates with the terminal devices. The disclosed techniques are thus easily scalable to support large numbers of terminal devices, and a given implementation may support on the order of several dozen terminal devices or more.

As indicated previously, portions of the STB 120 configured in accordance with the invention may be implemented as one or more integrated circuits. A given such integrated circuit may be installed, for example, on a printed circuit board or other support structure within the STB 120.

In a given integrated circuit implementation, identical die are typically formed in a repeated pattern on a surface of a semiconductor wafer. Each die includes a video processor or other device as described herein, and may include other structures or circuits. The individual die are cut or diced from the wafer, then packaged as an integrated circuit. One skilled in the art would know how to dice wafers and package die to produce integrated circuits. Integrated circuits so manufactured are considered part of this invention.

Again, it should be emphasized that the embodiments of the invention as described herein are intended to be illustrative only. For example, the particular arrangement of system elements as shown in FIG. 1 may be varied in alternative embodiments. The disclosed techniques can be adapted for use with other types of terminal devices and communication interfaces. Also, other types of software and processing and memory circuitry in any combination may be used to implement an STB or other network interface device with connection table management functionality as disclosed herein. In addition, the content management table format may be varied in other embodiments. These and numerous other alternative embodiments within the scope of the following claims will be readily apparent to those skilled in the art.

What is claimed is:

1. A method comprising:
receiving multimedia signals from an access network;
delivering selected ones of the multimedia signals to a plurality of terminal devices responsive to control commands received from the terminal devices; and
maintaining a connection management table indicating for each of the terminal devices at least a selected one of the multimedia signals and status information for that terminal device.

2. The method of claim 1 wherein the connection management table indicates a selected one of the multimedia signals utilizing a corresponding channel number.

3. The method of claim 2 wherein the connection management table comprises a plurality of channel groups with each such group identifying a plurality of channels by their respective channel numbers.

4. The method of claim 3 wherein the channel groups comprise at least a broadcast channel group and a video on demand channel group.

5. The method of claim 1 wherein the status information indicated in the connection management table for a given one of the terminal devices comprises an indicator as to whether the terminal device is in an on state or an off state.

6. The method of claim 1 wherein the connection management table comprises an active list and a pause list and wherein each of at least a subset of the terminal devices is on one of the active list and the pause list.

7. The method of claim 6 wherein a given entry in one of the active list and the pause list identifies a particular one of the terminal devices and a particular one of the multimedia signals currently selected by that terminal device.

8. The method of claim 6 wherein maintaining the connection management table further comprises:
detecting that a given one of the terminal devices has transitioned from an on state to an off state; and
responsive to said transition, removing the given terminal device from the active list and adding that terminal device to the pause list.

9. The method of claim 8 further comprising displaying the pause list on at least one of the terminal devices other than the given terminal device in conjunction with said other terminal device transitioning from an off state to an on state.

10. The method of claim 9 further comprising:
detecting selection by said other terminal device of a particular one of the multimedia signals from the displayed pause list; and
sending the selected multimedia signal to said other terminal device.

11. The method of claim 10 wherein maintaining the connection management table further comprises removing said other terminal device from the pause list and adding that terminal device to the active list.

12. The method of claim 6 wherein maintaining the connection management table further comprises:
detecting a tag command entered at a given one of the terminal devices; and
responsive to said tag command, updating the pause list to indicate the multimedia signal currently selected by the given terminal device.

13. The method of claim 12 further comprising displaying the pause list on at least one of the terminal devices other than the given terminal device in conjunction with said other terminal device transitioning from an off state to an on state.

14. A computer program product comprising a storage medium having executable computer program code embodied therein, wherein the computer program code when executed in a network interface device causes the device to perform the steps of the method of claim 1.

15. A network interface device comprising:
a processor;
a memory coupled to the processor;
first network interface circuitry for receiving multimedia signals from an access network;
second network interface circuitry for communicating over a local network with a plurality of terminal devices;
wherein the network interface device is operative under control of the processor to deliver selected ones of the multimedia signals to the terminal devices responsive to control commands received from the terminal devices;
wherein the memory stores a connection management table indicating for each of the terminal devices at least a selected one of the multimedia signals and status information for that terminal device.

16. The network interface device of claim 15 wherein the network interface device comprises a set-top box.

17. The network interface device of claim 15 wherein the first network interface circuitry comprises at least one of DSL circuitry, cable modem circuitry, satellite transceiver circuitry and Ethernet circuitry.

18. The network interface device of claim 15 wherein the second network interface circuitry comprises Wi-Fi circuitry.

19. A communication system comprising:
an access network; and
a plurality of network interface devices each coupled to the access network;
wherein at least a given one of the network interface devices is operative to receive multimedia signals from the access network, and to deliver selected ones of the multimedia signals to terminal devices of the communication system responsive to control commands received from the terminal devices; and
wherein the network interface device is further operative to maintain a connection management table indicating for each of the terminal devices at least a selected one of the multimedia signals and status information for that terminal device.

20. The system of claim 19 wherein a given one of the network interface devices is coupled to at least one of a DSL access multiplexer and a service port of the access network.
